(19) United States
(12) Patent Application Publication
(10) Pub. No.: US 2017/0242556 A1
(43) Pub. Date: Aug. 24, 2017

(54) NETWORK-BASED SYSTEM FOR GENERATION OF DIGITAL DATA OBJECT MOSAICS

(71) Applicant: Alaaeddin Yousef Al-Jallad, Al Huson (JO)

(72) Inventor: Alaaeddin Yousef Al-Jallad, Al Huson (JO)

(21) Appl. No.: 15/435,906

(22) Filed: Feb. 17, 2017

Related U.S. Application Data
(60) Provisional application No. 62/297,570, filed on Feb. 19, 2016.

(51) Int. Cl. G06F 3/0482; G06Q 50/00; G06Q 20/38; H04L 29/08

(52) U.S. Cl. CPC G06F 3/0482; H04L 67/141; G06Q 50/01; G06Q 20/38; G06F 2203/04804

(57) ABSTRACT

A network-based system is described for generating a digital data object mosaic. The system comprises: a data storage device for storing data objects; a network-accessible data server implementing a data object sharing platform comprising a sharing interface for presenting the data objects as visual representations; and a network connection for accessing the platform. The sharing interface comprises a digital mosaic for display in a user interface, the digital mosaic comprising a pre-selected background image and selectable tiles, at least some of which being associated with a data object, the association with a given selectable tile being indicated by a visual representation of an associated data object on the given selectable tile. The data object sharing platform accepts data objects from a given user in association with a specific selectable tile, and wherein subsequent selection of the specific selectable tile by a user provides access to the associated data object.

### FIELD OF TECHNOLOGY

This disclosure relates generally to a network-implemented system for implementing a multi-user digital mosaic of data objects, and more particularly, to a system and a method of creating digital, interactive mosaics from one or more data objects and related data.

### BACKGROUND

Mosaic is the art of creating images with an assemblage of small pieces of colored glass, stone, or other materials. The online field has witnessed an array of innovative solutions to problems of connecting people with each other, promotional strategies of companies, etc. There have existed numerous online concepts in which digital mosaics may be built for different purposes. A conventional online mosaic allows one person to create a mosaic under his/her control by choosing a background image and assembling small images. However, there is no way to express or share a mosaic's contents with other people. Therefore, the whole image consists only of one user's images. Some of the traditional arts are detailed below.

The Patent US 20140025456 A1 discloses a system for providing an artwork and financial based user selection system, enabling creation of a collaborative mosaic work of art. The collaboration is created by providing an initial poster image, wherein said initial poster image is divided into a plurality of poster sections; providing an administrator account and a plurality of donor accounts; receiving preliminary setup instructions from said administrator account; retrieving personal information, contact information, and donation amount from each of said donor accounts; uploading the images according to donations received and formatting each image as partially transparent image. The prior art is only used for the purpose of fundraising and the admin sanctions the user to place images on the Mosaic and the admin chooses the positioning of image. Furthermore, the disclosed system is not adapted for social media as the user interface lacks the vital software functional to provide users with the autonomy to place images on each tile. Further yet, users are not freely given the ability to control whether their mosaic (or reserved tiles) are private, friends only, or public.

Other traditional mosaic systems include US 2012/0303461 which is a method for creating an advertising image. The method includes soliciting a plurality of users to each provide at least one image from a social networking site, assembling a mosaic from images provided by the users into an advertising image, and attaching the advertising image to a three-dimensional object. In at least one alternative embodiment, the method includes soliciting a plurality of users to each provide at least one image from a social networking site; collecting a payment from each user submitting an image; assembling a mosaic from images provided by the users into an advertising image; arranging the advertising image to be placed upon a vehicle participating in a motor sports event; and attaching the advertising image to the vehicle. However, the vehicle is not the Internet, and companies must rely on users to generate mosaics to advertise their products. As such, the companies are limited in the number of mosaics that they can create.

Another Patent US 20080163059 A1 provides for video mosaic pages where custom pages may be locally-generated, remotely-generated, or partially locally-generated and partially remotely-generated. The custom pages may include local content, such as content recorded to a digital video recorder (DVR), overlaid on a multi-video composite feed. A local compositing system may render the mosaic pages and dynamically customize the pages based on user profile data, user preferences, and active user monitoring. However, this prior art does not provide for user-generated mosaic on a social networking site integrated with other social media.

Another Patent US 20140096021 A1 is a system for creating image and or text-based projects which includes a server, the server having access to a processor and a data repository, the server also including a non-transitory physical medium, and software running from the non-transitory physical medium, the software providing a first function for establishing a connection between the server and at least one mobile computing device connected to the network, a second function for initiating and maintaining an active data session between one or more users involved in project creation and or in project editing through a graphics user interface (GUI), a third function for providing an image container to visually display images selected by a user to add to a project, a fourth function for enabling view of image properties and selection order of the contained images, and a fifth function for enabling digital manipulation of the images while in the image container. However, despite these five functions, the above system does not provide a user interface for interactive mosaic generation where users may interact socially through mosaics and constituents of said mosaics.

Another Patent US20080133258A1 is a method of fundraising for a predetermined cause utilizing a photo-mosaic composition with an appearance approximating a target image that is representative of the cause, the target image being compiled from source images contributed by participant individuals wishful of advancing the cause. In this method a web site is set to host a clickable icon file of the photo-mosaic composition associated with a database of participant profiles that is searchable through an incorporated search engine. The web site allows networking of participant individuals. The photo-mosaic composition is rendered through available rendering software in predetermined time intervals and periodical printouts thereof are produced to provide outdoor exhibits to be displayed in public. In this method the scope of advancement of the predetermined cause and effective fundraising is achieved through the multiplier effect produced by the combination of outdoor and electronic promotional activities. However, the above system provides neither full autonomy to users or the ability to interact in real-time with mosaic compositions. Furthermore, the actual pieces of the mosaic are not interactive in that they are static descriptions of user profiles. In essence, it is no more than a visual database.

Another U.S. Pat. No. 8,923,551 B1 is a method for automatically creating a photo-based project based on photo analysis and image metadata. The method includes the steps of: receiving a plurality of images from a user-device, reading embedded metadata from the plurality of images, and storing said plurality of images in a data repository; performing photo analysis on the plurality of images in the data repository to determine a visual content and relevant metadata in the images; customizing the photo-based project automatically by performing one or more automatic customization actions based on the visual content in and the relevant metadata in the plurality of images; placing the plurality of images automatically in one or more particular page layouts of the photo-based project based on the customization performed and generating output. However, the photo-based project is not a hub of social interaction and does not provide the ability for users to collaborate in working on said photo-based project. As such, the method is limited to a single user and lacks GUI features for more sophisticated visual social media interactivity.

Another Patent US 20140153828 A1 is a method of creating a photographic mosaic, wherein a target image is recreated using a computer, comprising the steps of: creating an image library, and selecting one image in the image library to be the target image, selecting one or more images in the image library to be the source images, dividing the target image into a number of areas (squares or rectangles) of equal size, evaluating each area for luminance and assigning a luminance value for each area, evaluating the source images for luminance and assigning a luminance value for each image, re-sizing the source images to the size of the areas, and creating the photographic mosaic by placing a source image in every area of the target image by matching the luminance value of the area with the closest luminance value of a source image within a predetermined margin. However, the above method performs unnecessary steps for creating a digital mosaic by factoring in luminance. Furthermore, there is no software functionality for a GUI to make the digital mosaic interactive in a social media environment.

The Patent US 20140016147 A1 is a method where the number of images in the group may be determined. Possible template configurations for the group of images may be determined based on the number of images. Images may be ranked with respect to the possible template configurations. Overall rankings for the possible template configurations may be calculated and an optimal template configuration may be identified based on the overall rankings. A mosaic may be generated from the group of images in accordance with the optimal template configuration. The above method involves using template configurations, which is an unnecessary step when creating a digital mosaic. Having to choosing an optimal template may require further processing power and the results may be difficult to change and may lack consistency, which facilitates a predictable user experience.

The limitations and non-effectiveness of the prior art, as well as other limitations and shortcomings, have been overcome by the subject matter as described below. Other advantages will be apparent to those skilled in the art of the instant disclosure and the subject matter is not intended to be limited to the exemplary and illustrative embodiments and advantages disclosed hereinbelow.

### SUMMARY

The foregoing descriptions outline some pertinent features and objects of the subject matter of the instant disclosure. These descriptions may be illustrative of more exhaustive and comprehensive features described later in the application. Unless defined otherwise, the technical terms used in this document are meant with the same meaning as understood by a person skilled in the art of the field to which the instant disclosure relates.

In accordance with one aspect of the instant disclosure, there is provided network-based system for generating a digital data object mosaic, said system comprising a data storage device for storing a plurality of data objects; a network-accessible data server communicatively coupled to said data storage device, said data server implementing a data object sharing platform, said data object sharing platform comprising a sharing interface for accepting and presenting said data objects as visual representations; and a network connection associated with said network-accessible data server for accessing said data object sharing platform; wherein said sharing interface, when accessed on said sharing platform by a user interface via said network connection, comprises a digital mosaic for display in said user interface, the digital mosaic comprising a plurality of selectable tiles, at least some of said selectable tiles being associated with a data object, said association with a given selectable tile being indicated by a visual representation of an associated data object on said given selectable tile, and said digital mosaic having a background that is a pre-selected image; and wherein said data object sharing platform is configured to accept data objects from a given user from a plurality of users in association with a specific selectable tile, and wherein subsequent selection of said specific selectable tile by one or more of the plurality of users provides access to the data object associated therewith.

In another aspect, there is provided method of generating a digital data object mosaic, said method comprising providing access to a data object sharing platform instantiated on a network server, said data object sharing platform comprising a sharing interface for accepting and presenting a plurality of data objects as visual representations, said sharing interface, when accessed on said sharing platform by a user over a network via a user interface, comprises a digital mosaic for display in a user interface, the digital mosaic comprising a plurality of selectable tiles; accepting for storage, upon selection of a given selectable tile by one of said users, a given data object and associating the given selectable tile with said given data object associating the given selectable tile with a visual representation of the given data object; providing access to a stored data object upon selection by one of said users of the selectable tile associated with said stored data object.

The presently disclosed subject matter improves upon traditional mosaic systems. In embodiments of the presently disclosed subject matter may allow users to express their love, admiration, opposition, dislike, loyalty and enthusiasm to friends, family, beloved figures, country, city, state, sport teams, schools, businesses, political figures, leaders, celebrities, charities, sports stars, etc. Users may utilize the aspects of the instantly disclosed subject matter to build loyalty for their brand, support for their causes, etc. Embodiments of the presently disclosed subject matter may also function as an advertising and marketing intelligence platform. Profile information may be made available to other users via tile functionality, a functionality which is not just limited to images.

There are provided herein systems and methods for accepting and sharing data objects of any type by a plurality of users, in accordance with a visual format, which in some embodiments can be distributed as a distributable collection of data objects. Said distributable collection provides a unique way of combining said data objects visually, along with a means for interacting and contributing to said collection in accordance with one or more requirements, effects, and pre-determined user privileges.

These and other features, objects and advantages of the disclosed subject matter may be readily visible to persons ordinarily skilled in the art related to this field comprehending in entirety the above characteristics and the appended description and drawings.

### BRIEF DESCRIPTION OF THE DRAWINGS

The accompanying drawings illustrate the various embodiments of systems, methods, and other aspects of the disclosure. Any person with ordinary skill in the art will appreciate that any illustrated element boundary (e.g. boxes, groups of boxes, or other shapes) in the figures represents one example of the boundary. In some examples, one element may be designed as multiple elements, or multiple elements may be designed as one element. In some examples, an element shown is an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a process flowchart depicting a process of operation of a social media platform for mosaic generation, according to one or more embodiments.

FIG. 2A is a user interface showing a mosaic and one or more tiles thereof, according to one or more embodiments.

FIG. 2B is the user interface of FIG. 2A showing further social features within a tile, according to one or more embodiments.

Other features of the present embodiments will be apparent from the accompanying drawings and from the detailed description that follows.

### DETAILED DESCRIPTION

In the present disclosure, numerous specific details are provided, such as examples and methods, to provide a thorough understanding of embodiments of the instantly disclosed subject matter. Persons of ordinary skill in the art will recognize, however, that the instantly disclosed subject matter can be practiced as different embodiments hereof without one or more of the specific details described in association with the illustrative examples provided hereinbelow. In other instances, well-known details are not shown.

The present disclosure describes an online social platform for facilitating social interaction by rendering an electronic images, or other electronic media, into a digital, interactive mosaic. It transforms the image into a mosaic by the application of a user-defined virtual online grid (with any number of rows and columns or irregular shapes, said number of rows and/or columns being predefined or dynamically changeable) that creates a network of cells on top of the original image, which cells are referred to as tiles. Each tile may be a different shape (e.g. a square, a rectangle, or any other regular or irregular shape). Each tile may contain a tile image, which may initially be derived from the original uploaded image. The tile image may be resized to create a thumbnail image, and a transparency effect may be applied to each tile image to simulate a mosaic, and complete the transformation into a mosaic.

In a preferred embodiment, the user may upload the mosaic with the initial background image and may share the mosaic by providing access to it to the public or friends and/or followers of the user. As such, the mosaic may show by default to the followers in the timeline. The user may send invitations, but the mosaic may be readily visible to the followers or friends or to the public, any of whom may upload further images to the tiles or reserve one or more tiles for uploading images on the tile(s). The users may also be able to share the created mosaic in their respective social networking websites, in addition to MozaicMe™ platform, such as Facebook®, Twitter®, etc. As such, the created mosaic may be a social hub where users may comment, like, share, and/or reply to one or more tile(s). From the perspective of Facebook®, the mosaic may be considered a post.

In another preferred embodiment, the profile information of the contributing users may be made available to other users via tile functionality, which is not limited to images. Clicking on an active tile may expand the tile image thumbnail, and may function as a gateway to additional information about the user which is made available through their profile and associated permissions. Profile information and user activity can also be made available to advertisers and marketers utilizing the social platform to create and execute marketing campaigns. This social platform may also allow users to “like” different pages. For example, “Real Madrid Community Page”, a community/fan page for a popular soccer team, may have mosaics related to Real Madrid events or uploaded images. The users may like the page and share mosaics present on the page. Corporate marketing may also create a mosaic to market one or more brands, wherein advertisements that may or may not be directly related to the mosaic image could be associated with tile preview dialogs. The advertisements may be selected based on characteristics of the selecting user, the user that posted the mosaic, and/or of connections to such users.

In addition to popular social media interactions (for example, but not limited to “like”, “comment”, “share”, “download”, “play slideshow”, and other such functions) the aspects of the instantly disclosed subject matter may also allow the creation and use of custom verbs. For example, if the user needs to reserve a tile on Windows 10, he/she can select an “install” verb; if he/she reserves a tile on a Real Madrid mosaic, he/she can select a “support” verb.

Though a photo may be placed in a single tile, one or more adjacent or surrounding tiles may also be reserved. The system may split the photo into segments, each of which may be uploaded to the tile and the surrounding tiles. The system may also generate mosaic previews in case multiple photos or videos are uploaded; in some embodiments, the previews may constitute one or more frames of a video or set of photos associated with a given tile. The user may compare between previews and select the user's desired mosaic. The system may also allow selection by voting, in which a plurality of users may input their vote on a mosaic that represents their views. In some embodiments, the mosaic displayed on a user interface may be split into multiple views where each view can be another mosaic or part of the same or different mosaic. Each view may have dynamic number of tiles and can be generated on demand. For example, taking the case of an election, or policy poll, etc., the users who vote on or associate with a particular side of a given candidate or issue, may be provided access to a portion of the split mosaic that relates to their selection, and as more users select the same candidate or issue, that portion may get more tiles than the other.

In summary, this system may be useful in assisting social media interaction in at least the following ways:
Voting: a mosaic may be used to vote by creating mosaics visualizing the voting results.
A voting mosaic may be created, and may comprise tiles that may be reserved by users. Each user may be prompted to input his or her vote. This system could be used to vote for new product designs, sport teams, competitive products such as cars, competitive services such as airlines, polls for political figures, surveys, internal company reviews, etc. This feature may utilize smart tiling, described below.
Events: organize future event mosaics, in which functionality followers and/or friends may reserve tiles to indicate whether they are attending the future event
Smart Tiling: dynamic tiling can change the size of the grid overlay to maintain a complete mosaic. Though a minimum number of tiles may be chosen, a smart tiling mosaic automatically increases the maximum number of tiles of the mosaic. This may be suitable for political figures running for office (campaign financing, polls, voting, etc.), or for fundraising campaigns, product orders, etc.
Survey: ability for businesses such as corporations or hospitals to run a customer satisfaction survey Company team building: companies can create a mosaic of all employees working on a specific product or working within a department to build morale within the team
Product advertising: a mosaic for a new product can help with marketing or building a brand.
Hiring: companies could use it as a way to post new job openings
Real estate and tourism: showing photos of homes or tourist attractions
Patriotism: countries, sport teams, cities, etc.
Celebrities: new pictures, new movies released, best actors/actresses, opinions, communications with fans, etc.
E-Commerce: an e-commerce site (e.g. Amazon®) may tell a user how many people bought the product and whether purchasers they liked the product or not; a tech company (e.g. Apple®, Samsung®) may use it to showcase a new product and receive preorders.
The web site may also comprise pages where companies can create a page to market its brands and similarly other brands can also make their respective pages. The users may like the page and share mosaics present on the page or show their fan following for the brands or affiliation towards the respective companies.

The subject matter hereof specifically relates to creating a social network site in which a user may choose any picture as a background image, and in which the background image is split into a plurality of tiles, each of which may be interactive. The plurality of tiles collectively form a virtual online grid. The user may create tiles where each tile may hold an image which may be uploaded by the user. The user may post a tile to public or followers (friends). The user may reserve a tile to place one or more small thumbnail picture(s), like or share the mosaic, or comment on the images on the mosaic. “Reserve” may refer to a user action through which a tile that is reserved is maintained for use by that user. As such, a user may upload any kind of multimedia to the reserved tile. The reserved tile may represent the user in the context of the mosaic. The tile may have software functionality enabling the virtual mosaic to function as a user interface to a computing system. These mosaic designs may be used for multifarious purposes like fundraising, marketing, connecting people etc.

Individual users may reserve tiles in the virtual online grid for themselves. Profile information can be made available to other users via tile functionality, which is not just limited to uploading images. Clicking on an active tile may expand the tile image thumbnail, and may function as a gateway to additional information about the user which is made available through their profile and associated permissions.

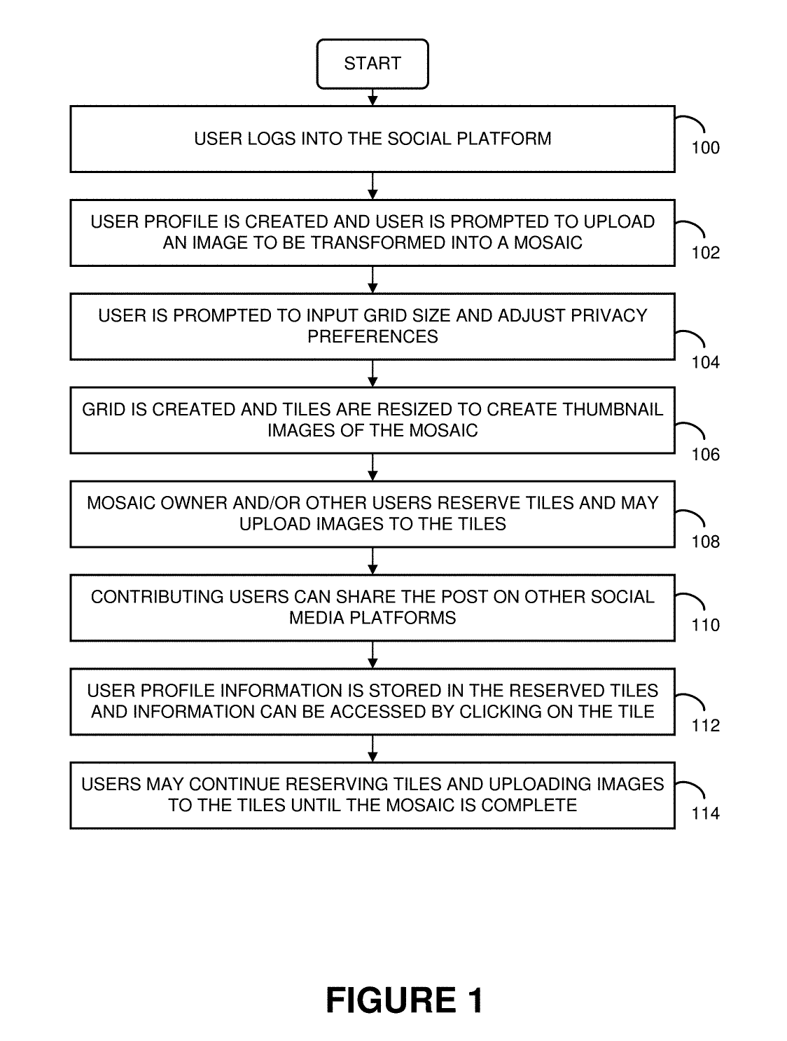

Reference is now made to FIG. 1, which is a process flowchart 100 depicting a process of operation of a social media platform for mosaic generation, according to one or more embodiments. The social media platform (also referred to hereinafter as “Mozaic”) is an Internet-based social media service that utilizes a virtual online mosaic interface to facilitate social interaction. Mozaic may allow users to express their love, admiration, loyalty and enthusiasm to friends, family, beloved figures, country, city, state, sport teams, schools, etc. Businesses, political figures, leaders, celebrities, charities, sports stars, etc. may use Mozaic to build loyalty to their brand and support for their causes. Mozaic may also function as an advertising and marketing intelligence platform. In step 100, the user will log in to the website by signing up with a username and password or by signing in via Facebook®, Gmail® or Twitter® account. Any social network may be integrated into Mozaic, so the user may be able to link to their LinkedIn®, Tumblr®, or Instagram® accounts, etc. All forms of social media integration are contemplated and are within the embodiments described herein.

After logging in, in step 102 the user account is created and the user may choose to fill in a user profile, in which personal details may be available to the public, to other users, and/or his follows. The user may also upload a profile picture. The user may then be prompted to upload an image to be transformed into a mosaic. In step 104, the user may be prompted to choose a number of tiles for a grid that may be generated and subsequently superimposed on the image in step 106. The grid may comprise one or more interactive tiles, each of which may store an image and additional information as described in this disclosure. Also in step 104, the user may be prompted to: choose whether the mosaic is free or paid, enter a description of the mosaic, and adjust privacy preferences for who can view the mosaic (public, followers/friends or only me). The number of tiles for the mosaic may determine the resolution of the grid. Once the user uploads the mosaic with the background or main image, a grid may be generated. In step 108, the user may upload multiple images where users may see the post on his profile or his timeline and interact with it in variety of ways.

The mosaic created comprises an online virtual grid which is a network of virtual lines that cross each other to form a series of rectangles (“tiles”) on top of a background image. These cells may hold any type of images (“cell images”) the user. The cell image may be resized to create a thumbnail image. A transparency effect may be applied to each cell image to give the effect of a mosaic. A user may also reserve tiles to upload images immediately or later, and this reservation may be free or paid depending on what user had chosen in step 104.

Businesses may use this platform to allure new customers or have current customers to show their love or loyalty to a brand. For example, Apple® could create a mosaic with the background image of its logo, the mosaic comprising a grid having any number of tiles. The system may allow users to login using their social media accounts such as Facebook®, Google+®, Twitter® or other social media accounts. The square or tile may be the base for the users' social interaction where friends can comment, like, and share with other followers on his network or with social media sites such as Facebook®, Google+®, etc. as outlined in step 110. In step 112, the platform may retrieve the user's social information and store it in a database. Then user may load an image or use one from his/her social media platform to be a cell image.

Each user who posts a cell image may have a post on his own social media profiles in various networks like Facebook®, Twitter®, Google+®, LinkedIn®, etc. to show that he participated in the mosaic. Software functionality of the tiles that enable an online virtual mosaic to function as a user interface to a computing system and the API's may be developed to interface with the tiles and the mosaic service. Profile information may be made available to other users via tile functionality, which is not just limited to images. Clicking on an active tile may expand the tile image thumbnail, and may function as a gateway to additional information about the user which may be made available through their profile and associated permissions. This interactive system may transform into a full-fledged mosaic, as outlined in step 114. Profile information and user activity may also be made available to advertisers and marketers utilizing Mozaic to create and execute marketing campaigns.

Some of the business models that can be anticipated for Mozaic may include free service with advertising, premium service without advertising and advanced features, special events services, promotions, marketing of particular brands, voting campaigns, fundraising services, taking popular opinions etc. The Mozaic disclosed may also allow the ability to store a video or an animated GIF in the tile and the user may have the ability to choose a picture to be the featured as a thumbnail in the tile.

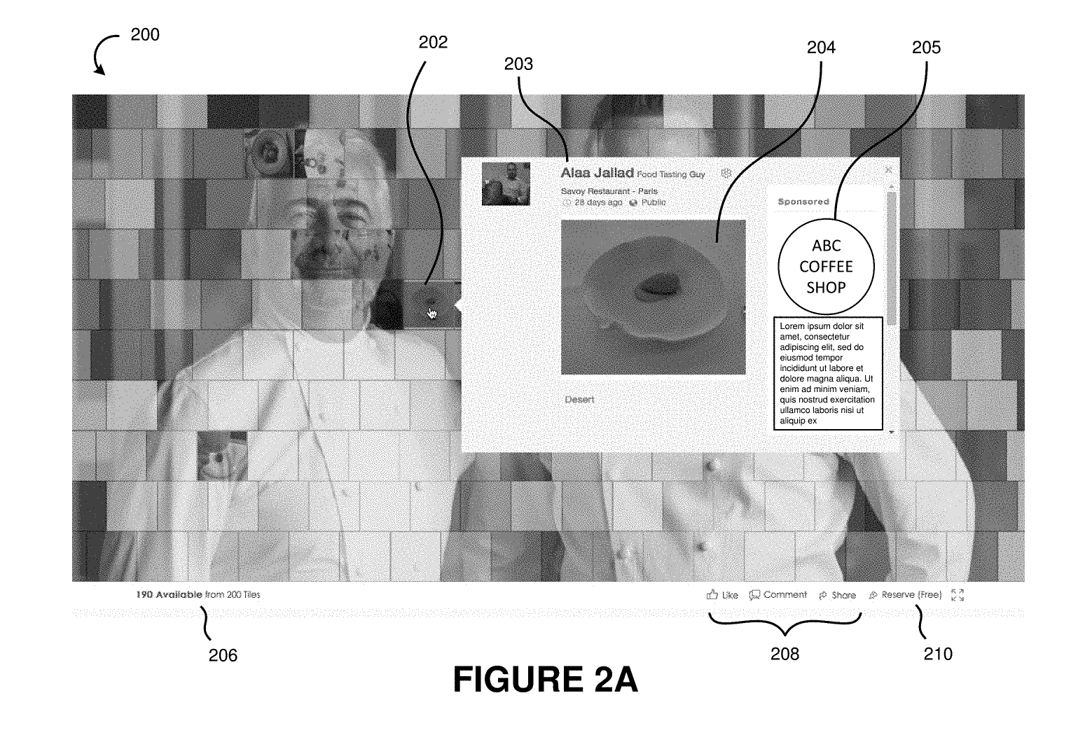

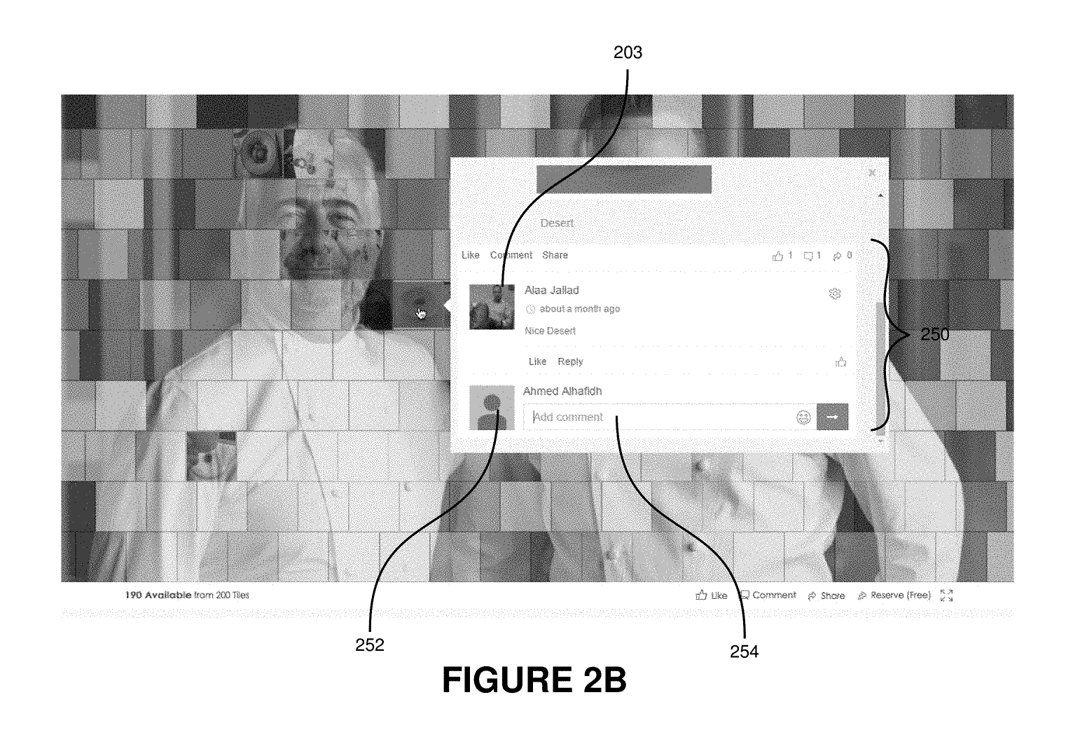

Reference is now made to FIG. 2A, which is one embodiment of a user interface for Mozaic, according to one or more embodiments. In one embodiment, mosaic 200 may be created with a plurality of tiles (e.g. tile 202), each tile comprising a thumbnail image that constitutes a portion of an initial image uploaded to Mozaic. Any number of tiles may be generated (i.e. there may be no maximum number of tiles), and the number of tiles may be chosen by a user of the system. In one embodiment, a tile 202 of the mosaic 200 may be reserved by a user 203. The user 203 may upload an image 204 to the tile 202. The image 204 may be related to the overall mosaic 200. In FIG. 2A, the image 204 is a sample dish prepared by the chefs working at the restaurant for which the mosaic 200 is created.

When viewing the image 204 uploaded by the user 203, an ad pane 205 may be shown. The ad pane 205 may be generated by an advertising platform and the ad pane 205 may be directly or indirectly related to the mosaic 200, or any content of the tile 202. In FIG. 2A, the ad pane 205 is sponsored by a coffee shop. When viewing the image 204, profile information of the user 203 may also be shown.

Below the mosaic 200 may be one or more tools for interacting with the mosaic 200. For example, an availability counter 206 may show how many tiles of the total number of tiles of the mosaic 200 are available for reservation. Additionally, as shown in FIG. 2A, social media controls 208 may be provided (e.g. “like”, “comment”, “share”) to allow interaction with the mosaic 200 and connection to other social media platforms. Additionally, a reserve feature 210 may allow a user viewing the mosaic 200 to reserve one or more available tiles of the mosaic 200.

Reference is now made to FIG. 2B, which shows further social features within the tile 202, according to one or more embodiments. Other social features may be accessed by exploring the tile 202 further. In addition to the profile information of the user 203, the tile 202 may also comprise a chat box 250 in which another user 252 may input messages in a message box 254. As such, the user 203 and the another user 252 may engage in a conversation. The conversation may be related to the image 204 of the tile 202 or may be related to the mosaic 200 or any other tile, or any other topic.

In one embodiment, there is provided a network-based system for generating a digital data object mosaic that may be associated with a collection of one or more data objects. The system comprises a data storage device for storing a plurality of data objects. The data storage device can comprise a database or a database server, a local storage device (e.g. a hard drive or flash device), network attached storage, or other data storage resource. The data storage device may refer to a virtualized data storage device hosted by local, remote, or third-party data storage services.

In some embodiments, there is provided a network-accessible data server. The network-accessible data server may comprise a server coupled to a communications network, and may comprise a web server or an application server. The data server may comprise a network access server (NAS), which can be a computer server that may refer to a server devoted entirely to managing network access or to a server that also performs other functions as well. The network-accessible data server is communicatively coupled to said data storage device over a network. The network may comprise in some embodiments the Internet. The data server and data storage device may be coupled to each other via a network connection; the data server is connected to the network for access by users and, in some cases, other social media platforms, by a network connection. The network connection may comprise an Ethernet or WiFi connection, or another type of connection for accessing a network.

In some embodiments, the data server provides a specific function of provisioning, and providing a plurality of users access to, a data object sharing platform for accepting and distributing data objects as part of distributable data collection. The data object sharing platform comprises a sharing interface for accepting and presenting said data objects as visual representations wherein the sharing interface makes available a predetermined image to visually render the collection as a shareable and interactive collection of data objects. The sharing interface, when accessed on the sharing platform comprises a digital mosaic for display in said user interface. The digital mosaic may comprise a pre-selected image, over which a plurality of selectable tiles or other selectable regions are overlaid. The selectable tiles or regions can be any shape; in some embodiments they are a grid or a set of squares and rectangles. Not all tiles or regions are the same size or shape in some embodiments. The term selectable tiles as used herein shall be understood to refer to either or both of selectable tiles or selectable regions as associated with a given digital mosaic.

In some embodiments, there is a user authentication process in order to ensure that the user using the sharing platform has the appropriate permissions to carry out specific functions, including but not limited to viewing and selecting tiles, uploading data objects, and creation and sharing of mosaics. A given user's privacy settings relating to what other users can do and how they can interact with a given mosaic; specific levels of privacy settings, established by the poster, creator, or other administrator of a given digital mosaic, can be associated with different permissions to carry out specific activities by another user. Authentication can be established by a profile established from another social media platform (e.g. Facebook), which will permit automatic provision of user credentials used for authenticating a given user. By selecting profile information for the other social media platform, with which the user may already be authenticated, the sharing platform can authenticate such a user automatically and even use information made available from the other social media platform (e.g. profile pictures, connections, other data objects, etc.).

In some embodiments, associations between mosaics, and/or portions and/or data objects associated therewith, can be created. The associations may be explicitly created by users (such as a poster, creator, administrator, or a class of users, depending on permissions relating to the mosaics to be associated) or they may be defined according to characteristics and/or themes relating to the mosaics or users associated with said mosaics. Based on characteristics of the mosaics (including but not limited to background images, themes, user characteristics), associations and permissions can be enabled for a given mosaic (or portion thereof). In this way, a user that has a relationship to a given theme, or has related characteristics, can be linked directly to other associated mosaics having a similar theme; other examples, may include the ability to reserve specific tiles, due to their prominence or association with said theme due to an explicitly or dynamically created link, by a given user also having a relationship to said theme. The relationship to a given theme or association may be created by virtue of other associations with other mosaics, themes, users, or data objects; or it may be created explicitly. In cases with dynamic association, upon selecting a data object or tile from a given mosaic, the selecting user may be automatically presented with one or more of messages or information relating to that theme, another associated mosaic, or data objects from another associated mosaic. In some cases, specific tiles on a selected and/or associated mosaic may be reserved for specific users that share the necessary relationship and/or characteristics which may be determined from their profile, usage history, or their connections (or the profiles and/or usage history of their connections). Reservations may also be based on privacy or other permissions independently, or concurrently with reservations based on associations and relationships.

In some embodiments, the sharing platform is made accessible by a user interface over said network connection through or being a web browser on a user device. In other cases, the user interface can be a dedicated application that is downloadable or otherwise acquirable by a user wishing to use or access the sharing platform. In some cases, the user interface may be an API or other executable that can be used by another application running on, or accessible, by a user device; for example, an API may be provided to allow another social medial platform or other application running on a user device (or another device that is accessible by the user device) to access the network server directly. In some embodiments, the user interface comprises a dedicated application that can be implemented by a user client device (e.g. a smartphone).

At least some of the selectable tiles can be associated with a data object. In general, when such an association is generated the selectable tile shall thereafter be presented with a visual representation that is representative of the associated data object. The visual representation may be an image or portion thereof that is representative of the data object: if the data object is an image, it may be a smaller and/or cropped version of the image data object; if a video or animation, it may be still image selected from the video or animation either by the user submitting the data object or by random, or it may be all or a portion of the video or animation rendered into the selectable tile space; for any type of file, it may be an image selected by the user, an image that is associated with a file type. In some cases, the visual representation is transparent (with, in some cases, with potentially different or varying degrees of transparency), so that the pre-determined image of the mosaic can be still be viewed. In these and other cases, the visual representation may be selected and/or amended to match the visual characteristics of the mosaic image behind so that when viewed together the selectable tiles appear as pixels of the larger mosaic image.

In aspects, the data object sharing platform is configured to accept data objects from users in association with a specific selectable tile when said given user selects an empty tile and uploads or provides access to a specific data object type. The data object type may or may not be associated with a theme or topic that is associated with the digital mosaic image and/or the collection of data objects overall. After such association, subsequent selection of selected tiles will provide access to the data object associated therewith. Upon such subsequent selection, the data object may be made more prominent (by, e.g. enlarging, rendering less transparent), including to provide access to information about the data object. The information may include characteristics of the data object, such as but not limited to who posted it, who created it, when it was posted or created, as well as commentary by the poster or other users upon viewing the data object. There may be an input interface for additional commentary and/or submission of content or links thereto. Each data object can thus become an individual running exchange between multiple users.

In some embodiments, the data object sharing platform can generate and package the collection as a distributable mosaic that comprises the digital mosaic image, having the same selectable regions, as well as all associations between such selectable regions and the previously associated data objects. In this manner, the distributable mosaic data object can be broadly shared amongst many different platforms and applications. For example, it may be distributable via email or other direct messaging platforms, as well as other social media platforms. Such social medial platforms may include, but are not limited to MozaicMe™, Facebook™, Instagram™, Twitter™, Snapchat™, LinkedIn™, Google+™, WhatsApp™, Tumblr™, Flickr™, Reddit™, Periscope™, Pinterest™, and YouTube™. The distributable mosaic image, which may be considered in some embodiments as a data object, can comprise the background image, the rows and columns (or other information defining the regions that make up the selectable tile portions), associations (e.g. between the digital mosaic data object and other digital mosaics, themes, information, users, or data objects), as well as the data objects associated with the selectable tiles of the digital mosaic.

In some embodiments, the data object can comprise any type of transmittable digital file or other non-file oriented data object. For example, it may comprise of a digital image, a digital video recording, a digital audio recording, a digital animation, and a digital document, or a digital text representation. It may take the form of any format currently used for such file or objects, including but not limited to: IMG, PNG, GIF, BPG, APNG, dynamic HTML, Flash, Shockwave, CSS, PNG Sprite, SVG, MNG, GIFV, WebP, JPEG, MPEG, or MOV. A data object may also comprise the interactive running exchange and subject matter and media exchanged therewith. It may also comprise the input fields that users can submit commentary, data objects, media, as well as a “like/dislike” or other pre-determined input fields. As such, the entire data object, including the ongoing interactive exchange can be viewed as part of the data object.

In some embodiments, the data object is associated with information the data storage device as one or more tables in a database. When we the mosaic is rendered, data from the database relating to a given mosaic is cached in the memory at the user device. Exemplary tables and metadata include but are not limited to:

The Mozaic Table (Containing the Main Information about the Mosaic) with Columns:

Type
type_id
title
photo
reservation_verb_id
mosaic_type_id
price
rows
columns
max_reservation
privacy
reservation_privacy
available_tiles
created_at
updated_at
is_featured
deleted_at
delete_reason
transparency
instant_reserve
greeting_status
greeting_img

The Tiles Table (Containing Information about Each Selectable Tile, Including Null Tiles):

ID
mosaic_id
type
type_id
title
photo
privacy
row
column
width
height
status
expiration_date
created_at
updated_at

### Comments Table (for Commentary Input):

ID
user_id
text
type
type_id
img_path
created_at
updated_at
delete_reason
deleted_at

Likes Table (for Data Associated with “Likes” and “Dislikes”):

ID
user_id
type
type_id
created_at
updated_at

Users Table (for Storing Data Related to Users, their Profiles and Privileges):

ID
Fullname
Username
email_address
password
gender
bio
profile_details
privacy_info
design_info
cover
country
fully_started
avatar
auth
auth_id
verified
admin
active
activated
hash
remember_token
last_active_time
created_at
updated_at
city
online_status
banned
birth_day
birth_month
birth_year
language
delete_reason
deleted_at
zoom
facebook_authID
twitter_authID
google_authID

In some embodiments, ability to submit, or even access, data objects by a given user requires that user to first take a specific action. This can include paying or making a binding promise to pay. In such a way, the mosaic digital mosaic can form part of a fundraising activity. Alternatively, payment may cause the visual representation or the selectable tile to change depending on a timing or an amount of payment. Upon such payment, possibly with a certain amount or within a certain specified timeframe, information may be received by sharing platform to update the tile, users, and/or mosaic table to facilitate the reaction from such payment. This may include, but is not limited to, making certain tiles available, changing the size or location of a given tile, changing the transparency of a tile, or making the tile accept specified types of data objects. In some embodiments, payment may be required in advance and in response the user will be given the ability to select a tile and associated it with a data object of their choosing. Payment amounts may be associated with more prominent tiles, including larger, combined tiles, control over splits in mosaics, and more central or prominent locations. These payment amounts may be determined dynamically, for example, depending on prior payment amounts or predefined; said payment amounts may be stored in the data server, whereupon the data object sharing platform communicates with said data server storage facility to determine whether such an amount has been achieved, the effect associated with a given amount, and to store said any new amount.

In some embodiments, the digital mosaic consists of two parts:

(a) Background layer, often comprising an image: the user may be permitted to choose the background image, as well as the transparency level between 1-100, after which a background image is stored in the data storage device and applied; (b) Tiles layer that makes up the front layer: the original image is not changed but the transparency is applied in two ways. The first way is to render the image on the screen by applying the transparency on the image using cascading style sheet effects. The other is to render the image for mosaic and tile reservation preview snapshot by rendering the tiles on the background image and apply a transparency, for example, using values between 35-45. Using PHP image functions, or other image functions, the tiles and the background image have specified, varying, and/or adjustable transparency. The transparency level may differ from tile to tile, which can give better mosaic feel and look.

While specific embodiments of the present disclosure have been provided, it is to be understood that these embodiments are illustrative and not restrictive. Many additional embodiments will be apparent to persons of ordinary skill in the art reading this disclosure.

1. A network-based system for generating a digital data object mosaic, said system comprising:
a data storage device for storing a plurality of data objects;
a network-accessible data server communicatively coupled to said data storage device, said data server implementing a data object sharing platform, said data object sharing platform comprising a sharing interface for accepting and presenting said data objects as visual representations; and
a network connection associated with said network-accessible data server for accessing said data object sharing platform;
wherein said sharing interface, when accessed on said sharing platform by a user interface via said network connection, comprises a digital mosaic for display in said user interface, the digital mosaic comprising a plurality of selectable tiles, at least some of said selectable tiles being associated with a data object, said association with a given selectable tile being indicated by a visual representation of an associated data object on said given selectable tile, and said digital mosaic having a background that is a pre-selected image; and
wherein said data object sharing platform is configured to accept data objects from a given user from a plurality of users in association with a specific selectable tile, and wherein subsequent selection of said specific selectable tile by one or more of the plurality of users provides access to the data object associated therewith.

2. The system of claim 1, wherein said data object sharing platform generates a distributable mosaic data object comprising the digital mosaic and all associations between the selectable tiles thereof and the associated data objects.

3. The system of claim 2, wherein the distributable mosaic data object is distributable via a social media platform.

4. The system of claim 3, wherein the social media platform comprises one of: MozaicMe™, Facebook™, Instagram™, Twitter™, Snapchat™, LinkedIn™, Google+™, WhatsApp™, Tumblr™, Flickr™, Reddit™, Periscope™, Pinterest™, and YouTube™.

5. The system of claim 1, wherein the data object comprises a data object file, data object information, and one or more data object input fields.

6. The system of claim 5, wherein the data object file comprises at least one of: a digital image, a digital video recording, a digital audio recording, a digital animation, a digital document, and a digital text representation.

7. The system of claim 6, wherein the digital animation uses one of the following formats: GIF, BPG, APNG, dynamic HTML, Flash, Shockwave, CSS, PNG Sprite, SVG, MNG, GIFV, WebP, JPEG, MPEG, or MOV.

8. The system of claim 5, wherein the one or more data object input fields for a given data object accepts input as data object information from one of the plurality of users when the selectable tile corresponding to said given data object has been selected.

9. The system of claim 1, wherein the visual representations, upon selection by one of the users, are displayed more prominently by at least one of: reducing transparency of the selected visual representation, increasing the size of the selected visual representation, displaying the data object input with the selected visual representation, and displaying the data object input field of the selected visual representation.

10. The system of claim 1, wherein the visual representation is representative of the data object file.

11. A method of generating a digital data object mosaic, said method comprising:
providing access to a data object sharing platform instantiated on a network server, said data object sharing platform comprising a sharing interface for accepting and presenting a plurality of data objects as visual representations, said sharing interface, when accessed on said sharing platform by a user over a network via a user interface, comprises a digital mosaic for display in said user interface, the digital mosaic comprising a plurality of selectable tiles;
accepting for storage, upon selection of a given selectable tile by one of said users, a given data object and associating the given selectable tile with said given data object;
associating the given selectable tile with a visual representation of the given data object; and
providing access to a stored data object upon selection by one of said users of the selectable tile associated with said stored data object.

12. The method of claim 11 further comprising:
generating a distributable mosaic data object comprising the digital mosaic and all associations of data objects associated with selectable tiles in said digital mosaic.

13. The method of claim 12, wherein the distributable mosaic data object is distributable via a social media platform.

14. The method of claim 13, wherein the social media platform comprises one of: MozaicMe™, Facebook™, Instagram™, Twitter™, Snapchat™, LinkedIn™, Google+™, WhatsApp™, Tumblr™, Flickr™, Reddit™, Periscope™, Pinterest™, and YouTube™.

15. The method of claim 11, wherein the data object comprises a data object file, data object information, and one or more data object input fields.

16. The method of claim 15, wherein the data object file comprises at least one of: a digital image, a digital video recording, a digital audio recording, a digital animation, a digital document, and a digital text representation.

17. The method of claim 16, wherein the data object file comprises digital animation, and the digital animation uses one of the following formats: GIF, BPG, APNG, dynamic HTML, Flash, Shockwave, CSS, PNG Sprite, SVG, MNG, GIFV, WebP, JPEG, MPEG, or MOV.

18. The method of claim 15, wherein the one or more data object input fields for a selected data object accepts input as data object information from at least one of the one or more users upon selection of the selectable tile associated with the given data object.

19. The method of claim 15, wherein at least one of the visual representations are representative of the data object file.

20. The method of claim 11, wherein the step of accepting the data object from a given user requires payment by the given user.
